(19) United States
(12) Patent Application Publication
(10) Pub. No.: US 2025/0114976 A1
(43) Pub. Date: Apr. 10, 2025

(54) SYSTEM EQUIPPED WITH INSERT FOR WORKING ON HARD AND ABRASIVE SURFACES

(71) Applicant: CORIMAG S.R.L., BOSCONERO (TO) (IT)

(72) Inventor: Giovanni ANDRINA, Bosconero (IT) (IT)

(21) Appl. No.: 18/729,738

(22) PCT Filed: Nov. 24, 2022
(86) PCT No.: PCT/IT2022/050301

§ 371 Date: Jul. 17, 2024

(30) Foreign Application Priority Data
Jan. 24, 2022 (IT) 102022000001115

(51) Int. Cl. B28D 1/18; B23P 11/02

(52) U.S. Cl. CPC B28D 1/186; B23P 11/027

(57) ABSTRACT

A system (1) for working hard and abrasive surfaces is provided. The system has a support and containment structure (3) equipped with a containment hole (5), and a spindle (7) to be inserted in the containment hole (5). The spindle is elongated and has a conical section with a first diameter (A) oriented towards the outside of the structure (1) and a second diameter (B) greater than the first diameter (A) and oriented towards the inside of the structure (1) and a conical section with a third diameter (A′) oriented towards the outside of the structure (1) and a fourth diameter (B′) greater than the first diameter (A′) and oriented towards the inside the structure (1). the spindle (7) is inserted into the containment hole (5) by raising or reducing the temperature of the support and containment structure (3).

The present invention refers to a system equipped with an insert for working on hard and abrasive surfaces. In general, the invention relates to a system to be used in applications having the problem of a tension caused by thermal mounting due to interference. Still in general, the invention can be used with all materials that develop thermal expansion. Finally, in particular, the invention refers to an improved tool for working on hard and abrasive surfaces.

Tools equipped with an insert (core) inserted inside the tool structure are known in the art: this insert is made from a special tungsten alloy with high hardness (up to 60 HRC) and resistant to very high temperatures (up to 500° C.).

The service life is certainly much longer than a standard tool, with some precautions. During work, the wear of the insert is minimal, but it must be considered that the steel which forms the external part of the tool has other characteristics of hardness and thermal resistance, and therefore it is necessary to avoid overheating of the tool with long stroke times, since a temperature higher than 500° C. would generate problems for the part of the steel tool that holds the insert.

To obtain optimal performance, working on very hard materials (800 kg/cm² and above), it is necessary to start the demolition with minimum portions and reduced beating times, which allow for good production (in relation to the hardness of the material), even if they involve a greater commitment and greater attention on the part of the operator.

The tungsten part is always protruding from the rest of the steel tool, which wears when is in contact with the rock, so that the tool is always sharp, making it easier to position it in the best attachment point and allowing to concentrate all the hammering power on a small surface, thus increasing the breaking factor.

However, these tools are not satisfactory and, as will be better seen later on, have the problem that the structure is unable to guarantee the support of the insert (which is cylindrical in shape) and, after a very few work cycles, it breaks due to the stresses to which the structure is subjected (starting from the circular hole made in the structure to contain the insert) by the insert itself.

EP-A2-2 812 532 discloses a prior art system having the above-mentioned problems. DE-U1-20 2005 011770 discloses a cylindrical recess 11 of the receiving element 3 which has a rectangular section, while the receiving element has a slightly tapered shape when coupled with the coupling mandrel 2, namely in another position with respect to the present invention.

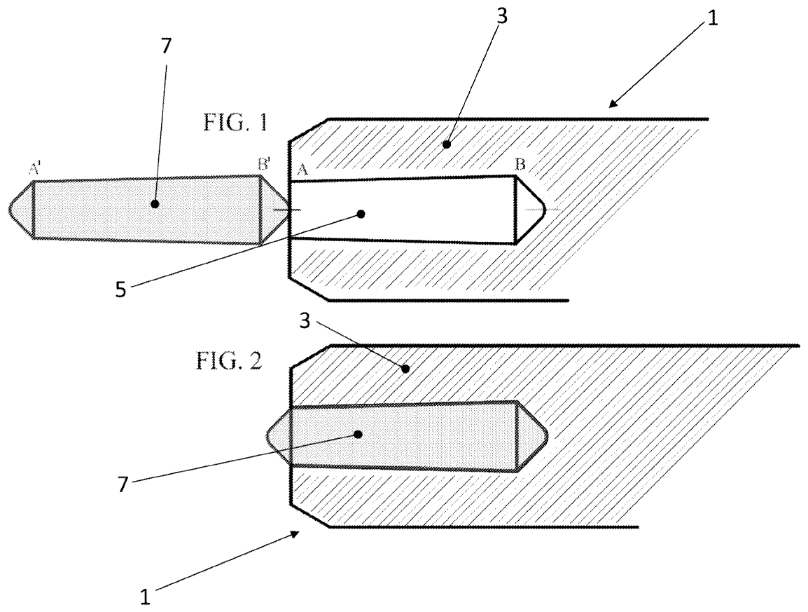

Moreover, given that, as can be clearly seen in FIG. 1 of DE-U1-20 2005 011770, the coupling between the parts 2 and 3 takes place by placing the receiving element 3 externally with respect to the mandrel 2, the conical realization of their coupling part it would not lead to any improvement, in consideration of the very high operating speeds of the mandrel 2, given that the external coupling element 3 would be dislodged after a short time due to these operating speeds. This regardless of the orientation of the tapers of a mandrel 2 (which, by the way, is never usually conical) towards the outside or towards the inside of the support: the operating speed would immediately undermine the coupling element 3 (and therefore the tool connected thereto) from the mandrel 2 whatever type of taper is adopted in that position.

Therefore, DE-U1-20 2005 011770 actually does not provide any direct teaching (from the Figures the cavity is cylindrical, with a rectangular section) or even any indirect teaching (the mention of the taper in the Description is even a teaching contrary to that of the present invention) on how to reach the solution of the present invention starting from EP-A2-2 812 532.

Object of the present invention is solving the aforementioned prior art problems, by providing a system equipped with an insert for working on hard and abrasive surfaces in which the coupling between the insert and the support structure is achieved in a simple and effective way, avoiding any type of breakage of the structure itself.

The above and other objects and advantages of the invention, as will appear from the following description, are achieved with a system equipped with an insert such as the one described in claim 1. Preferred embodiments and non-trivial variations of the present invention form the subject matter of the dependent claims.

It is understood that all attached claims form an integral part of the present description.

The present invention will be better described by some preferred embodiments thereof, provided by way of non-limiting example, with reference to the attached drawings, in which:

FIG. 1 is a schematic sectional side view of the two components of the system according to the present invention in a separate position; and

FIG. 2 is a schematic sectional side view of the two components of the system according to the present invention in a coupled position.

Referring to the Figures, a preferred embodiment of the insert system of the present invention is illustrated and described. It will be immediately obvious that innumerable variations and modifications (for example e relating to shape, dimensions, arrangements and parts with equivalent functions) may be made to what is described, without departing from the scope of protection of the invention as appears from the attached claims.

The system 1 of the invention comprises:
a support and containment structure 3 equipped with a containment hole 5; and
a spindle 7 designed to be inserted in the containment hole 5.

The containment hole 5 is elongated and has a conical section with a first diameter A oriented towards the outside of the structure 1 and a second diameter B greater than the first diameter A and oriented towards the inside of the structure 1.

The spindle 7 is elongated and has a conical section with a third diameter A′ oriented towards the outside of the structure 1 and a fourth diameter B′ greater than the first diameter A′ and oriented towards the inside of the structure 1.

The first diameter A and the third diameter A′ are substantially identical, just as the second diameter B and the fourth diameter B′ are substantially identical.

The insertion of the spindle 7 inside the containment hole 5 takes place by raising the temperature of the support and containment structure 3, realizing an expansion of the first diameter A which allows the spindle 7 to enter the hole 5. The same object is obtained by reducing the temperature of the spindle 7, thus reducing the diameter B′. All diameters and temperatures are precisely designed in order to obtain functional expansions and contractions for the desired purpose.

The operational coupling of the spindle 7 inside the containment hole 5 takes place through the uniformity of the temperature of the two structures, restoring to them the original measurements which prevent the spindle 7 from coming out of the hole 5.

In particular, the second diameter B is greater than the first diameter A and the fourth diameter B′ is greater than the third diameter A′.

Preferably, the spindle 7 is made of tungsten alloy with a hardness higher than 60 HRC and resistance to temperatures up to 500° C., while the support and containment structure 3 is made of steel.

The invention therefore relates to a system equipped with a special insert made using a mechanical solution for the assembly, hot and with interference, of the spindles 7 which must remain securely in place without undergoing the effects of load and tensile stress, to which both the spindle 7 and the reciprocal seat 5 are subject due to the mechanical interference caused by the assembly which exploits the thermal expansion of the hole 5 where they are inserted.

Normally, the prior art solutions adopted for a hot interference assembly provide that the parts to be assembled are cylindrical and not conical as the solution of the present Application, and in particular that the spindle 7 has a larger diameter than the hole 5, when both objects are at the same temperature. The extent of the increase depends on the thermal expansion that can be obtained in the hole 5 by applying heating to the temperature allowed by the technical specifications. Thermal expansion is a very precise value linked to the type of material and the temperature.

When the diameter of the hole 5, when it has reached the heating temperature, has increased by the expected amount and has become greater than the diameter of the spindle 7 (which has a lower temperature), the spindle 7 can be inserted without any effort.

When both parts return to the same temperature, an extremely solid assembly will have been obtained, which applies a very high force radially between the two pieces which prevents relative movement.

It has been found that this very high load has contraindications in some applications, for example if the parts are used under shock or vibration: breakages occur due to this load, which puts the fibres of the material under very high tension, which gradually begin to yield until complete rupture.

The proposed solution achieves the assembly, without the possibility of extracting the spindle 7, but with a minimum or even zero radial load.

In the situation illustrated in the Figures, in which, in the hole 5, the first diameter A is smaller than the second diameter B and, in the spindle 7, the third diameter A′ is smaller than the fourth diameter B′, at the same temperature the fourth diameter B′ of the spindle 7 is greater than the first diameter A of the hole 5 and the pieces cannot be coupled (FIG. 1). By heating the structure 3 to the temperature evaluated in the project, the first diameter A increases until it exceeds the fourth diameter B′ of the spindle 7 which at this point can be freely inserted in the hole 5.

The same effect can be obtained by lowering the temperature of the spindle so that the diameter B′ becomes smaller than A and the spindle 7 can be inserted in the hole 5.

When both parts return to the same temperature, we will have obtained an extremely solid assembly, which does not allow the spindle 7 to be extracted, but does not apply significant radial loads since the two tapers are coupled but not in interference (FIG. 2).

This solution solves the problems due to the tensions generated by interference fitting.

Some preferred embodiments of the present invention have been illustrated and described above: obviously, numerous variations and modifications, functionally equivalent to the previous ones, which fall within the scope of protection of the invention as highlighted in the attached claims, will be immediately apparent to those skilled in the art.

1. A system comprising:
a support and containment structure having an outside and an inside and provided with a containment hole extending from the outside of the support and containment structure to the inside of the support and containment structure; and
a spindle designed to be inserted in the containment hole;
wherein the containment hole is elongated and has a first end oriented towards the outside of the support and containment structure having a first diameter, and a second, opposite end oriented towards the inside the support and containment structure having a second diameter;
wherein the spindle is elongated and has a a first end oriented towards the outside of the support and containment structure having a third diameter, and a second, opposite end oriented towards the inside of the support and containment structure having a fourth diameter;
wherein the first diameter and the third diameter are substantially identical;
wherein the second diameter and the fourth diameter are substantially identical;
wherein the first diameter is smaller than the second diameter and the third diameter is smaller than the fourth diameter;
whereby the spindle is not allowed to be extracted from the containment hole, but does not apply significant radial loads since the conical shape of the spindle and the conical shape of the containment hole are coupled but not in interference.

2-3. (canceled)

4. The system according to claim 1, wherein the spindle is made of tungsten alloy with a hardness higher than 60 HRC and resistance to temperatures up to 500° C.

5. The system according to claim 4, wherein the support and containment structure is made of steel.

6. The system according to claim 1, wherein the support and containment structure is made of steel.

7. A method for manufacturing a system, comprising:
a support and containment structure, having an outside and an inside and provided with a containment hole extending from the outside of the support and containment structure to the inside of the support and containment structure; and
a spindle designed to be inserted in the containment hole;
wherein the containment hole is elongated and has a first end oriented towards the outside of the support and containment structure having a first diameter, and a second, opposite end oriented towards the inside the support and containment structure having a second diameter;
wherein the spindle is elongated and has a first end oriented towards the outside of the support and containment structure having a third diameter, and a second, opposite end oriented towards the inside of the support and containment structure having a fourth diameter;
wherein the first diameter and the third diameter are substantially identical;
wherein the second diameter and the fourth diameter are substantially identical;
wherein the first diameter is smaller than the second diameter and the third diameter is smaller than the fourth diameter;
said method comprising:
raising the temperature of the support and containment structure, thus dilating the containment hole until the first diameter becomes greater than the fourth diameter;
inserting the spindle inside the containment hole;
making the temperature of the support and containment structure uniform with the spindle realizing the return to the original dimensions where the fourth diameter is greater than the first diameter;
whereby the spindle is not allowed to be extracted from the containment hole, but does not apply significant radial loads since the conical shape of the spindle and the conical shape of the containment hole are coupled but not in interference.

8. A method for manufacturing a system, comprising:
a support and containment structure, having an outside and an inside and provided with a containment hole extending from the outside of the support and containment structure to the inside of the support and containment structure; and
a spindle designed to be inserted in the containment hole;
wherein the containment hole is elongated and has a first end oriented towards the outside of the support and containment structure having a first diameter, and a second, opposite end oriented towards the inside the support and containment structure having a second diameter;
wherein the spindle is elongated and has a first end oriented towards the outside of the support and containment structure having a third diameter, and a second, opposite end oriented towards the inside of the support and containment structure having a fourth diameter;
wherein the first diameter and the third diameter are substantially identical;
wherein the second diameter and the fourth diameter are substantially identical;
wherein the first diameter is smaller than the second diameter and the third diameter is smaller than the fourth diameter;
said method comprising:
lowering the temperature of the spindle, thus shrinking the spindle until the fourth diameter becomes smaller than the first diameter,
inserting the spindle inside the containment hole;
making the temperature of the spindle uniform with the support and containment structure realizing the return to the original dimensions where the fourth diameter is greater than the first diameter;
whereby the spindle is not allowed to be extracted from the containment hole, but does not apply significant radial loads since the conical shape of the spindle and the conical shape of the containment hole are coupled but not in interference.
